(19) United States
(12) Patent Application Publication
(10) Pub. No.: US 2003/0196488 A1
(43) Pub. Date: Oct. 23, 2003

(54) Magnetic level indicator float retainer

(76) Inventors: Tommy M. Mann, Baton Rouge, LA (US); Donald P. Sanders, Baton Rouge, CA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/124,101

(22) Filed: Apr. 17, 2002

(51) Int. Cl. G01F 23/36

(52) U.S. Cl. 73/313

(57) ABSTRACT

A magnetic level indicating system comprises a chamber for fluidic coupling to a process vessel whereby material level in the vessel equalizes with material level in the chamber. A magnet actuated visual indicator is mounted to the chamber for indicating level in the chamber. A float is in the chamber for rising and falling with material level in the chamber. The float comprises a tubular wall defining an interior space. A plurality of elongate magnets are in the interior space. The magnets are parallel to the axis of the tubular wall and are circumferentially spaced along the tubular wall. A circular retainer in the interior space has circumferentially spaced notches receiving the magnets and retaining the magnets along the tubular wall.

### FIELD OF THE INVENTION

This invention relates to a magnetic level indicator and, more particularly, a magnetic level indicator including a float retainer.

### BACKGROUND OF THE INVENTION

Numerous technologies exist for measuring level of liquids or solids in an industrial process environment. Among these are a magnetic level indicator. A magnetic level indicator is constructed of a chamber, a float and a visual indicator. The chamber, also known as a cage, is essentially a pipe or similar device external to a process tank or vessel which is usually mounted vertically and which is usually connected to the tank through two or more horizontal pipes. One of the horizontal pipes is near the bottom of the chamber and the other is near the top of the chamber. This arrangement allows the material level in the chamber to equalize with the material level in the tank, largely isolating the chamber from agitation, mixing or other activities in the tank. The tank, which is usually a pressure vessel, can be isolated from the chamber using valves. The float is sized and weighted for the specific gravity and pressure of the application and contains magnets which actuate a visual indicator on the outside of the chamber to indicate level.

One typical float design includes a single magnet providing a horizontal magnetic field. Thus, the field differs around the periphery of the float. Another typical float design includes a plurality of magnets vertically mounted within the float. The magnets are held in place using a corrugated holder. Each magnet is held in a pocket between the float outer wall and the corrugated holder. However, such a design does not provide ideal spacing between individual magnets resulting in spaces having weaker magnetic fields. Also, if the float is jarred, the magnets may become dislodged from the holder. Also, the magnets are relatively small so that the overall magnetic field is smaller.

The present invention is directed to solving one or more of the problems discussed above in a novel and simple manner.

### SUMMARY OF THE INVENTION

In accordance with the invention, a magnetic level indicating system uses a float retainer for retaining magnets.

Broadly, there is disclosed herein a magnetic level indicating system comprising a chamber for fluidic coupling to a process vessel whereby material level in the vessel equalizes with material level in the chamber. A magnet actuated visual indicator is mounted to the chamber for indicating level in the chamber. A float is in the chamber for rising and falling with material level in the chamber. The float comprises a tubular wall defining an interior space. A plurality of elongate magnets are in the interior space. The magnets are parallel to the axis of the tubular wall and are circumferentially spaced along the tubular wall. A circular retainer in the interior space has circumferentially spaced notches receiving the magnets and retaining the magnets along the tubular wall.

It is a feature of the invention that the retainer is of a non-magnetic material such as stainless steel.

It is another feature of the invention to provide first and second angular rings in the interior space in parallel with the retainer and with the plurality of the elongate magnets sandwiched between the angular rings. The tubular wall includes first and second longitudinally spaced crimps for retaining the first and second angular rings and the plurality of the elongate magnets there between.

It is another feature of the invention that the angular rings are of a magnetic material such as carbon steel.

There is disclosed in accordance with another aspect of the invention, in a magnetic level indicating system including a chamber for fluidic coupling to a process vessel whereby material level in the vessel equalizes with material level in the chamber and a magnetic actuated visual indicator mounted to the chamber for indicating the level of the material in the chamber, an improved float in the chamber for rising and falling with material level in the chamber. The float comprises a tubular wall and first and second end caps at opposite ends of the tubular wall to define an interior space. A plurality of elongate magnets are aligned parallel to an axis of the tubular wall and circumferentially spaced along the tubular wall. A circular retaining ring in the interior space has circumferentially spaced notches receiving the magnets. Means are provided for retaining the magnets and the retaining ring in the interior space with the magnets along the wall.

It is a feature of the invention that the retaining means comprises welded joints connecting the retaining ring to the tubular wall.

Further features and advantages of the invention will be readily apparent from the specification and from the drawings.

### BRIEF DESCRIPTION OF THE DRAWINGS

FIG. 1 is an elevation view of a magnetic level indicating system in accordance with the invention mounted to a process vessel;

FIG. 2 is a schematic view of the magnetic level indicating system of FIG. 1;

FIG. 3 is a partially cutaway, elevation view of a float of the magnetic level indicating system of FIG. 1;

FIG. 4 is a sectional view taken along the line 4-4 of FIG. 3; and

FIG. 5 is a plan view of a retainer of the float of FIG. 3.

### DETAILED DESCRIPTION OF THE INVENTION

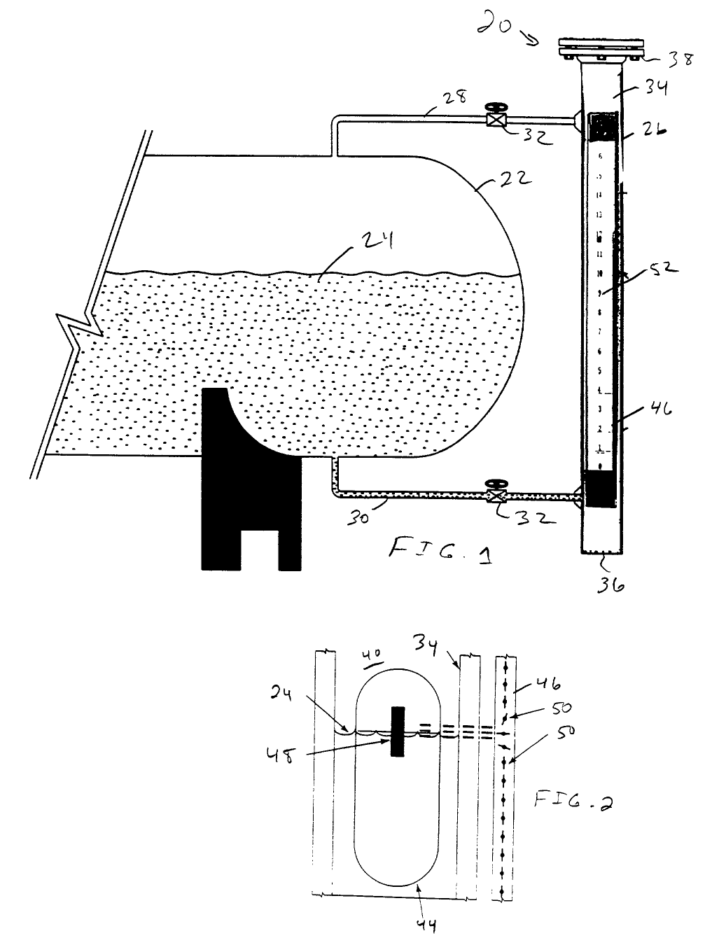

In accordance with the invention, a magnetic level indicating system 20, see FIG. 1, is used for providing level measurement of a tank or vessel 22 having a material 24, the level of which is to be sensed. The magnetic level indicating system 20 includes a chamber 26 for fluidic coupling to the vessel 22 via a first horizontal pipe 28 near the top of the vessel 22 and a second horizontal pipe 30 near the bottom of the vessel 22. The vessel 22 can be isolated from the chamber 26 using a valve 32 in each of the top pipe 28 and the bottom pipe 30.

The chamber 26 comprises an elongate pipe 34 closed at a bottom 36 and having a top flange 38 to define an interior space 40, see FIG. 2. The described arrangement allows the material level in the vessel 22 to equalize with level in the chamber 26 while largely isolating the chamber 26 from agitation, mixing or other activities in the vessel 22.

The magnetic level indicating system 20, see also FIG. 2, includes a float 44 in the chamber interior space 40 and a magnet actuated visual indicator 46. The float 44 rides up and down in the chamber 26 at the surface of the material 24. The float 44 is typically hollow so that it rides freely on the surface of the material 24. The float 44 is sized and weighted for the specific gravity and pressure of the application. The float 44 may be made of stainless steel or the like and houses a magnet assembly, in accordance with the invention, referenced schematically at 48, adapted to be positioned at the surface of the material 24. As such, the float 44 is also referred to herein as a magnetic float. The visual indicator 46 is strapped to the chamber 26 in a conventional manner and is totally isolated from the process material 24. The visual indicator 46 includes rotating flags 50. Each flag 50 contains an alignment magnet (not shown) which reacts to the float magnet 48 and protects against false actuation. With rising level, the flags 50 rotate, changing color. The floats are positioned alongside graduated markings 52 on the visual indicator 46 to indicate level of the material 24.

In accordance with the invention, the float 44 uses a retainer in the form of a retaining ring to support magnets therein to provide a more durable float having a stronger and more uniform magnetic field.

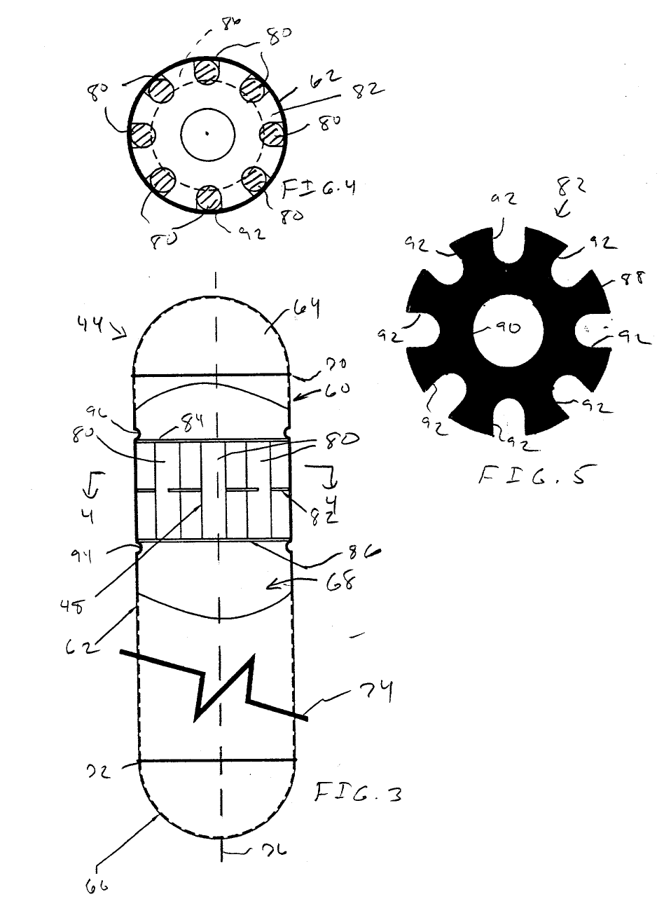

Referring to FIGS. 3-5, the float 44 includes a three piece housing 60. The housing 60 comprises a tubular wall 62, a top end cap 64 and a bottom end cap 66 to define an interior space 68. The end caps 62 and 64 are generally in the shape of hemispheres. The tubular wall 62 and end caps 64 and 66 are of a non-magnetic material, such as stainless steel. The top end cap 64 is connected to a top end of the tubular wall 62 using a weld ring 70. Similarly, the bottom end cap 66 is connected to the bottom end of the tubular wall 62 using a weld ring 72. The height of the float 60 is determined by an axial length of the tubular wall 62 which can varied, as represented by the line 74, according to the specific gravity and pressure of the application. The tubular wall 62 defines a central axis represented by a dashed line 76.

The magnet assembly 48 comprises eight individual magnets 80, a retainer 82 and first and second flux rings 84 and 86. Referring also to FIG. 5, the retainer, or retaining ring, 82 is illustrated. The retaining ring 82 comprises a circular plate 88 having a diameter slightly less than an inner diameter of the tubular wall 62. The plate 88 includes a circular central opening 90. Eight equally circumferentially spaced U-shaped notches 92 are provided around the periphery of the circular plate 88. Particularly, each notch 92 is angularly spaced forty-five degrees from each adjacent notch 92. In the illustrated embodiment of the invention, each notch 92 has a depth of approximately 0.325 inches and a width of approximately 0.325 inches. In fact, each notch 92 is generally circular, having a diameter of 0.325 inches, with the peripheral opening being widened to 0.325 inches. The diameter of the retaining ring 82 is approximately 1.96 inches for use with a two inch diameter float. The thickness is approximately 0.02 inches. The retaining ring 82 is of a non-magnetic material, such as stainless steel.

The magnets 80 comprise elongate magnets circular in cross section as shown in FIG. 4. The diameter of the magnets is approximately 0.325 inches to fit within the notches 92.

The flux rings 84 and 86 comprise annular washers of a magnetic material such as carbon steel.

To assemble the float 44, the bottom end cap 66 is welded to the tubular wall 62, as described. A feeder crimper puts a crimp in the form of a circular reverse bead 94 in the tubular wall 62 at a select location. The magnets 80 are inserted in the retaining ring notches 92. Particularly, the retaining ring 82 is positioned approximately at a mid-point longitudinally of each magnet 80. The magnets 80 are all oriented in the same direction, i.e., all with north on the same side of the retaining ring 82 and all with south on the same side of the retaining ring to provide a true north and south. The bottom flux ring 86 is inserted into the interior space resting on the reverse bead 94. The retaining ring 82 with the magnets 80 is lowered into the interior space 68 with the magnets 80 resting on the bottom flux ring 86. The retaining ring 82 can be spot welded to the tubular wall 62, if desired. The top flux ring 84 is then positioned on top of the magnets 80 in the interior space 68. A feeder crimper is then used to crimp the tubular wall 92 just above the flux ring 84 to provide a top reverse bead 96 to securely hold the magnet assembly 48 in place.

With the described construction, the magnets are securely held in place and equally spaced relative to one another. The use of the flux rings 84 and 86 in combination with the magnets 80, provides a true north and south. The retaining ring 82 being of a non-magnetic material acts as a structural reinforcement but does not split the magnetic field into two.

The use of the retaining ring 82 in combination with the magnets 80, provides a higher gauss rating, allowing the use of fewer magnets with higher individual masses. This provides greater saturation with a higher field. For example, using eight magnets, a field strength of 100 gauss may be obtained. The magnetic field is more perfectly aligned because the retaining ring 82 maintains precise spacing of the magnets 80 with a tolerance of 0.005.

Thus, in accordance with the invention, there is provided a magnetic level indicator including an improved magnetic float retainer.

We claim:

1. A magnetic level indicating system comprising:
a chamber for fluidic coupling to a process vessel whereby material level in the vessel equalizes with material level in the chamber;
a magnet actuated visual indicator mounted to the chamber for indicating level in the chamber; and
a float in the chamber for rising and falling with material level in the chamber, the float comprising a tubular wall defining an interior space, a plurality of elongate magnets in the interior space, the magnets being parallel to an axis of the tubular wall and circumferentially spaced along the tubular wall, and a circular retainer in the interior space having circumferentially spaced notches receiving the magnets and retaining the magnets along the tubular wall.

2. The magnetic level indicating system of claim 1 wherein the retainer is of a non-magnetic material.

3. The magnetic level indicating system of claim 1 wherein the retainer is of stainless steel.

4. The magnetic level indicating system of claim I retainer ring and with the plurality of elongate magnets sandwiched between the annular rings.

5. The magnetic level indicating system of claim 4 wherein the tubular wall includes first and second longitudinally spaced crimps for retaining the first and second annular rings and the plurality of elongate magnets there between.

6. The magnetic level indicating system of claim 4 wherein the annular rings are of a magnetic material.

7. The magnetic level indicating system of claim 4 wherein the annular rings are of carbon steel.

8. In a magnetic level indicating system including a chamber for fluidic coupling to a process vessel whereby material level in the vessel equalizes with material level in the chamber and a magnet actuated visual indicator mounted to the chamber for indicating level of the material in the chamber, an improved float in the chamber for rising and falling with material level in the chamber, comprising:
a tubular wall;
first and second end caps at opposite ends of the tubular wall to define an interior space;
a plurality of elongate magnets, the magnets being aligned parallel to an axis of the tubular wall and circumferentially spaced along the tubular wall;
a circular retainer ring in the interior space having circumferentially spaced notches receiving the magnets; and
means for retaining the magnets and the retaining ring in the interior space with the magnets along the tubular wall.

9. The improved float of claim 8 wherein the retaining ring is of a non-magnetic material.

10. The improved float of claim 8 wherein the retaining ring is of stainless steel.

11. The improved float of claim 8 wherein the retaining means comprises first and second annular rings in the interior space in parallel with the retaining ring and with the plurality of elongate magnets sandwiched between the annular rings.

12. The improved float of claim 11 wherein the retaining means further comprises first and second longitudinally spaced crimps in the tubular wall for retaining the first and second annular rings and the plurality of elongate magnets there between.

13. The improved float of claim 11 wherein the annular rings are of a magnetic material.

14. The improved float of claim 11 wherein the annular rings are of carbon steel.

15. The improved float of claim 8 wherein the retaining means comprises weld joints connecting the retaining ring to the tubular wall.
